(19) United States
(12) Patent Application Publication
(10) Pub. No.: US 2007/0211664 A1
(43) Pub. Date: Sep. 13, 2007

(54) Communication relay apparatus in a wireless communication network

(75) Inventors: Takuji Oyama, Kawasaki (JP); Hidehiko Suzuki, Kawasaki (JP); Tatsuhiro Ando, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/504,681

(22) Filed: Aug. 16, 2006

(30) Foreign Application Priority Data
Mar. 13, 2006 (JP) 2006-67841

(51) Int. Cl. H04B 7/00; H04Q 7/00; H04Q 7/20

(52) U.S. Cl. 370/331; 455/436; 370/310.2

(57) ABSTRACT

A communication relay apparatus is provided that shortens the time of communication relay during handovers, while reducing the load on communication relay apparatuses so as to enable application to large-scale networks. The communication relay apparatus sets static tunnels only with communication relay apparatuses for which the frequency of handovers is high and with communication relay apparatuses for which the probability of occurrence of handovers is high, and sets dynamic tunnels with other communication relay apparatuses. For communication relay apparatuses with which static tunnels are set, data packets are transferred via the static tunnel; for communication relay apparatuses with which static tunnels are not set, a dynamic tunnel is set, and data packets are transferred via the dynamic tunnel.

### CROSS-REFERENCE TO RELATED APPLICATIONS

This application is based upon and claims the benefit of priority from the prior Japanese Patent Application No. 2006-67841, filed on Mar. 13, 2006, the entire contents of which are incorporated herein by reference.

### BACKGROUND OF THE INVENTION

1. Field of the Invention

The present invention relates to a communication relay apparatus in a wireless communication network, such as a wireless LAN switch, and in particular relates to a communication relay apparatus capable of optimally switching and selectively using dynamic tunnels and static tunnels in handover processing.

2. Description of the Related Art

When a portable IP telephone terminal moves between access points (APs) of a wireless LAN during communication, motion is made possible while maintaining the communication session by a communication relay apparatus called a wireless LAN switch. A wireless LAN switch is also called an access router, and hereafter will be called an access router. An access router performs centralized management and control of AP settings, radio wave management, position information for terminals connected to an AP, and similar; traffic for wireless LAN terminals connected to an AP is all collected by an access router using tunnel technology.

When the terminal moves, traffic is transferred to the destination AP with the access router which collects traffic as a base point, and even if the terminal moves during a call, by having the destination AP maintain the IP address acquired at the AP prior to motion, the remote party (terminal, SIP server, or similar) is not made aware of the fact that the terminal has moved. That is, even if the terminal moves, by maintaining the IP address the communication session is not interrupted.

Within the access router is a unit which coordinates with other access routers and performs handover processing. Here, even in a case of movement between APs connected to different access routers, a static tunnel is set in advance between the access routers, and during movement packets travel in the tunnel, so that packets can be transferred to the destination AP for the terminal.

A tunnel is a closed virtual direct communication circuit which connects two certain points on the Internet, a wireless LAN network, or another public circuit network. It is called a tunnel because it appears to create a closed route on the network which is blocked and not visible from outside.

A packet written with a protocol with which communication is originally to be performed is wrapped in (encapsulated by) a packet in another protocol, which is transmitted to effect communication. Packet encapsulation, and encapsulation removal, are performed automatically by equipment at both ends of the tunnel; equipment connected by the tunnel need not take into consideration the communication method enroute or the path, and there is the appearance that the equipment at both ends of the tunnel are directly connected.

Because it is often the case that tunnels are used for connection of private networks via the Internet, for example when connecting the LANs of a main office and a branch office, actual tunneling equipment and software often have security functions which perform encryption during packet encapsulation, so that packets being transferred cannot be viewed or altered.

When using this method of setting a tunnel in advance, because a tunnel is set in advance in contrast with methods in which a tunnel is set each time handover occurs, there is the advantage that during handover the duration of communication interruption is short. For realtime communication such as IP telephony, it is desirable that the duration of communication interruptions be short.

In this Specification and in the Claims, when a tunnel is set in advance between access routers, the tunnel is called a “static tunnel”; and when a tunnel is set each time communication occurs between access routers, and the tunnel is destroyed at the end of the communication, such a tunnel is called a “dynamic tunnel”. That is, the dynamic tunnel is a temporary tunnel.

Japanese Patent Laid-open No. 2002-325275 discloses a dynamic route setting method for mobile communication, in which the mobility of a moving node is predicted, the time of occurrence of a handover is judged, and a new data route is set in advance of the handover, so that in the event of handover from a certain router to another router, packet latency, packet jitter, and packet losses are reduced.

Japanese Patent Laid-open No. 2004-180123 discloses a wireless LAN system which, prior to handover of a mobile unit, secures bandwidth for the parent station which is forecast to be the destination, and avoids the time loss required to secure the bandwidth necessary for QoS control.

As the network scale increases, and the area over which terminals can move expands, the number of wireless APs increases, and the number of access routers which control and manage APs increase, so that the number of tunnels between access routers to provide handover between access routers also increases. As a result, if the method of setting static tunnels between access routers in advance is used, the number of tunnels becomes larger as the number of access routers in the network increases, and the load on access routers becomes considerable, so that there is the problem that application to a large-scale network is difficult.

Hence in light of the above problems, an object of this invention is to provide an access router (communication relay apparatus) which reduces the load on wireless relay apparatuses while shortening the time for communication relay during handover, so that application to large-scale networks is possible.

### SUMMARY OF THE INVENTION

In order to attain the above object, a first configuration of a communication relay apparatus of this invention is a communication relay apparatus which relays communication data between wireless terminals, and is characterized in having judgment means which, upon detection of a communication connection with a wireless terminal which has moved from the domain of another communication relay apparatus, judges whether a static tunnel with the other communication relay apparatus has been set; and, control means which, when a static tunnel has been set, executes handover processing to transfer via the static tunnel to the wireless terminal communication data addressed to the wireless terminal which has been transferred from the other communication relay apparatus, and to transfer communication data from the wireless terminal to the other communication relay apparatus via the static tunnel, and, when a static tunnel has not been set, dynamically sets a tunnel with the other communication relay apparatus, executes handover processing to transfer to the wireless terminal via the dynamic tunnel communication data addressed to the wireless terminal which is transferred from the other communication relay apparatus and to transfer communication data from the wireless terminal to the other communication relay apparatus via the dynamic tunnel, and after the completion of handover processing, destroys the dynamic tunnel.

A second configuration of a communication relay apparatus of this invention is the above first configuration, characterized in further having setting means which, when a static tunnel with the other communication relay apparatus is not set, if the frequency of handover processing with the other communication relay apparatus exceeds a prescribed value, sets a static tunnel with the other communication relay apparatus.

A third configuration of a communication relay apparatus of this invention is the above second configuration, characterized in that, when the static tunnel is set with the other communication relay apparatus, if the frequency of handover processing with the other communication relay apparatus falls to become equal to or less than the prescribed value, the setting means destroys the static tunnel with the other communication relay apparatus.

A fourth configuration of a communication relay apparatus of this invention is the above first configuration, characterized in further having setting means which, based on a prescribed condition relating to handover, selects, from among a plurality of other communication relay apparatuses, a part of communication relay apparatuses comprising at least said other communication relay apparatus, and sets in advance fixed static tunnels with the portion of communication relay apparatuses.

A fifth configuration of a communication relay apparatus of this invention is the above fourth configuration, characterized in that the prescribed condition is an average number of handovers in an average call time of the other communication relay apparatus.

By means of this invention, a communication relay apparatus can execute either handover processing using a static tunnel or handover processing using a dynamic tunnel, and so communication with any communication relay apparatus is possible even when a static tunnel is set only to a part of communication relay apparatuses, and dynamic tunnels are set with the other communication relay apparatuses.

By setting static tunnels with communication relay apparatuses with which handovers occur frequently, communication interruptions can be shortened, and by setting dynamic tunnels at the time of handover with access routers for which handovers do not occur frequently, handover processing can be performed, the number of tunnels with communication relay apparatuses can be reduced, and the load on communication relay apparatuses can be alleviated.

By this means, a communication relay apparatus is provided which can be applied to large-scale networks having numerous communication relay apparatuses.

### BRIEF DESCRIPTION OF THE DRAWINGS

FIG. 1 shows the overall configuration of a wireless communication network of this invention;

FIG. 2 is a functional block diagram of an access router 10;

FIG. 3 is a functional block diagram of a position information management server 40;

FIG. 4 explains a method of terminal position information notification and management;

FIG. 5 explains the range over which a static tunnel is set;

FIG. 6 is a flowchart of access router handover processing in an aspect of the invention;

FIG. 7 shows in summary handover processing when a static tunnel is set;

FIG. 8 shows in summary handover processing when a dynamic tunnel is set; and,

FIG. 9 is a table showing tunnel setting states according to handover frequency.

### DESCRIPTION OF THE PREFERRED EMBODIMENTS

Below, aspects of the invention are explained referring to the drawings. However, these aspects do not limit the technical scope of the invention.

An access router of this invention sets static tunnels only with access routers with high handover frequency and access routers for which there is a strong possibility of the occurrence of handover, and sets dynamic tunnels with other communication relay apparatuses. In the case of an access router for which a static tunnel has been set, data packets are transferred via the static tunnel; in the case of an access router for which a static tunnel has not been set, a dynamic tunnel is set, and data packets are transferred via the dynamic tunnel.

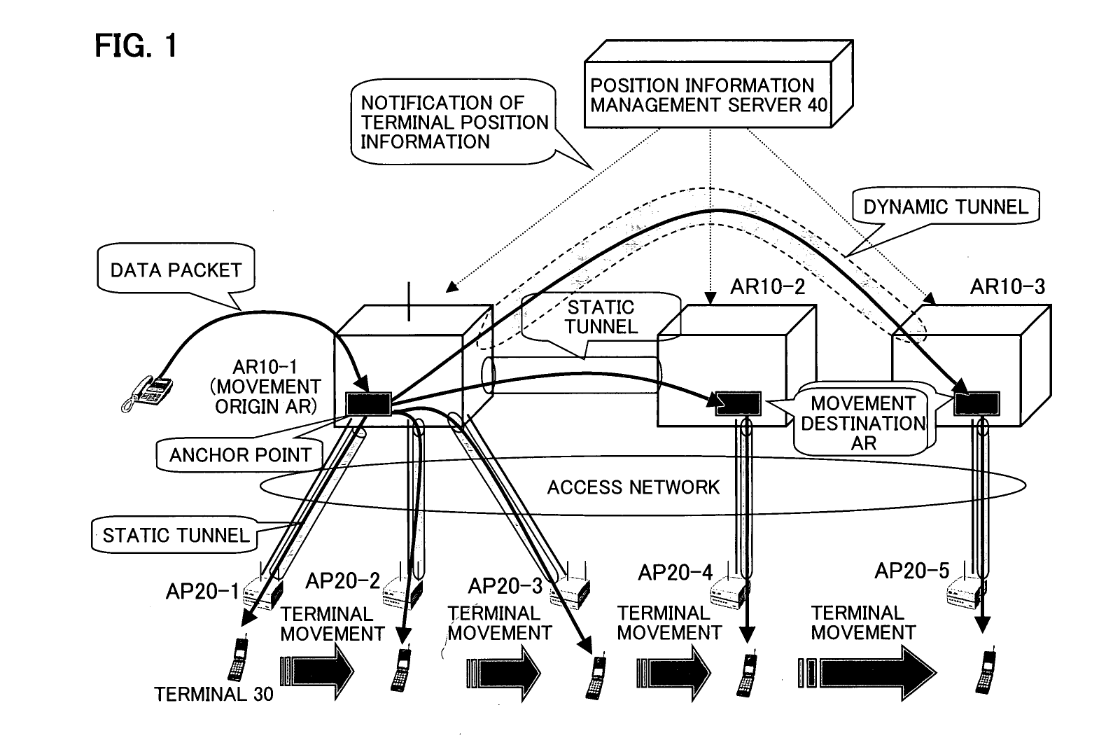

FIG. 1 shows the overall configuration of a wireless communication network of this invention. The network has a plurality of access routers (which may be abbreviated to “AR” below), which are communication relay apparatuses, and a plurality of access points (which may be abbreviated to “AP” below) which are connected thereto. A plurality of access points can be connected in the domain of a single access router. Static tunnels are set between access routers and access points. In FIG. 1, access router 10-1 is connected to three access points 20-1, 20-2, 20-3, access router 10-2 is connected to access point 20-4, and access router 10-3 is connected to access point 20-5. When individual access routers and access points are not specified, the general terms “access router 10” and “access point 20” will be used.

An access point 20 is a communication relay apparatus which connects an access router 10 with a wireless communication terminal 30 which is connected to perform wireless communication, and is connected by wire to the access router 10. The access point 20, upon receiving a data packet addressed to the wireless communication terminal 30 from the access router 10 to which it is connected, transmits the data packet to the wireless communication terminal 30, and upon receiving a data packet from the wireless communication terminal 30, transmits the data packet to the access router 10 to which it is connected.

The access router 10 is for example a wireless LAN switch, which performs routing in the direction of the wireless communication terminal (hereafter “terminal”) 30 to which a data packet is addressed. When the destination terminal 30 is a terminal connected to an access point 20 in the domain of the access router 10, the access router 10 routes the data packet in the direction of the access point 20; and when the destination terminal 30 is a terminal connected via an access point in the domain of another access router 10, the data packet is routed in the direction of the other access router 10. At this time, when a static tunnel is set with the other access router 10, the data packet is transferred via the tunnel. For example, as shown in FIG. 1, the data packet is transferred from the access router 10-1 to the other access router 10-2.

On the other hand, when a static tunnel is not set with the other router 10, after setting a dynamic tunnel with the other router 10, the data packet is transferred to the other access router 10 via this tunnel. For example, as shown in FIG. 1, a data packet is transferred from the access router 10-1 to the outer access router 10-3.

As explained above, a static tunnel is a tunnel which is set in advance between access routers 10; the tunnel always exists regardless of whether there is data packet communication. When data packet transfer between access routers is necessary, data packets can be transferred between access routers without waiting for the time needed to set a tunnel, so that the time of interruption of communication during handovers is comparatively short, making this method suitable for voice communication where realtime communication is required. However, the larger the number of static tunnels, the greater is the burden on the access routers 10. A dynamic tunnel is a tunnel which is set each time communication occurs between access routers 10. When there is no data packet communication, no tunnels exist; a tunnel is set only when communication occurs, and after the end of communication the tunnel is destroyed. At the time of occurrence of communication, time is required to set the tunnel, so that the time of interruption of communications during a handover is longer than when a static tunnel is used.

A wireless communication terminal 30 is a terminal which for example is capable of IP (Internet Protocol) telephone calls; as shown in FIG. 1, the terminal 30 moves to accompany user movement. As a result of movement, because the range over which communication with the access point 10 is possible is approximately several tens of meters, when the terminal 30 moves the access point 20 which is connected to the terminal 30 is switched in succession. At this time, when switching from access point 20-3 to access point 20-4, the access router 10 is also switched, and consequently handover processing between access routers is performed. In the case of FIG. 1, handover processing is performed between the movement origin access router 10-1 and the movement destination access router 10-2.

In handover processing, a tunnel is set between the movement origin access router 10-1 and the movement destination access router 10-2, data packets from the terminal 30 are transferred from the movement destination access router 10-2 to the movement origin access router 10-1 via the tunnel, and data packets addressed to the wireless communication terminal 30 are transferred from the movement origin access router 10-2 to the movement destination access router 10-1 via the tunnel. The procedure for handover processing is explained below.

The position information management server 40 is a server which ascertains and manages the positions of each terminal 30 in the network. The server 40 is notified by access routers 10 of the MAC addresses and IP addresses of each terminal 30 communicating with access points 20, as well as the IP addresses of access routers 10 connected to each of the terminals 30. Upon receiving notification from a certain access router 10, the server 40 notifies other access routers 10 in the network of the contents of the notification.

An access router 10 holds information contained in notifications from the server managing the position information for the terminals 30, and for terminals 30 which have initiated communication with access points 20 in its domain, uses MAC addresses as key information to judge whether there is information for terminals 30 which have initiated communication with access points 20 in its domain among the position information for terminals 30 in a notification from the server 40.

If this judgment indicates that there is no matching information, the access router 10 recognizes the terminal 30 as a terminal which has initiated new communication with the access point 20, and notifies the server 40 of the MAC address and IP address of the terminal 30, as well as the IP address of the access router 10 connected via the access point 20 to the terminal 30 (the IP address of the access router itself).

If however the judgment indicates that there is matching information, then if an IP address of the access router 10 associated with the terminal 30 is the IP address of another access router, then the access router 10 judges that the terminal 30 has moved from the other access router. The access router 10 then acquires the IP address of the movement origin access router to which the terminal 30 was connected at the time of initiation of new communication from the notification information from the server 40, and queries the movement origin access router as to whether the terminal 30 is still communicating.

As the means of querying the movement origin access router, either means of directly querying the movement origin access router by the access router 10 which is the movement destination, or means of querying the movement origin access router via the server 40, may be used.

The access router 10 receives the result of the query as to whether the terminal is communicating from the movement origin access router, and if the result indicates that the terminal is communicating, performs handover processing with the movement origin access router.

If the result of the query as to whether the terminal 30 is communicating indicates that the terminal is not communicating, the access router 10 does not perform handover processing. At the time that the terminal 30 acquires an IP address in the movement destination network, the access router 10 connected with the terminal 30 via an access point 20 notifies the server 40 of the MAC address and IP address of the terminal 30 as well as the IP address of the access router 10 to which the terminal 30 is connected (the IP address of the access router itself).

As handover processing which is characteristic of this invention, the access router 10 can perform either processing in which a tunnel is set in advance with the movement origin access router, and this constantly-set tunnel (static tunnel) is used to transfer data packets, or processing in which a tunnel is set only upon receiving a query result indicating that the terminal is communicating, and this tunnel (dynamic tunnel) is used to transfer data packets.

Further, the access router 10 measures the number of occurrences of handover processing with other access routers in the network within a fixed time, and can set a continuous tunnel (a static tunnel) with those other access routers for which the number is greater than a prescribed threshold, and for those other access routers for which the number is equal to or less than the prescribed threshold, does not set a tunnel in advance, but can set a tunnel only when handover processing occurs (sets a dynamic tunnel). That is, switching between setting of static tunnels and dynamic tunnels according to the frequency of handover processing with an access router is possible.

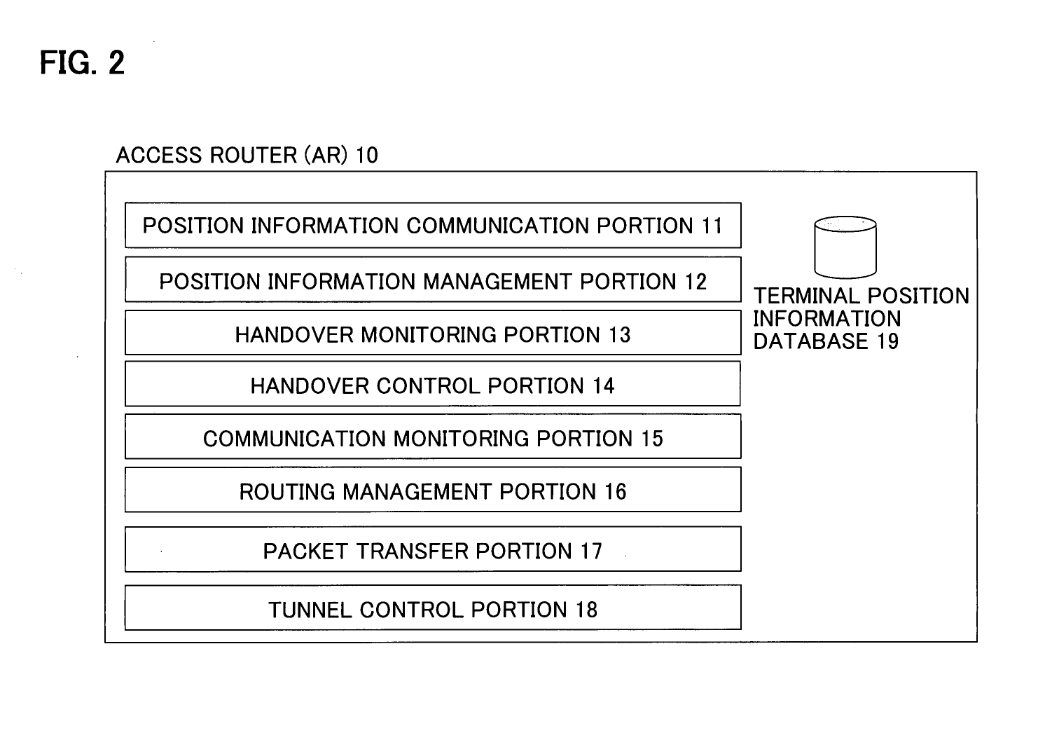

FIG. 2 is a functional block diagram of an access router 10. The position information communication portion 11 transmits and receives position information for terminals 30 with the position information management server 40. The position information management portion 12 manages MAC addresses and IP addresses for terminals 30 in association with the IP address of the access router itself or the IP addresses of access points 20 in the domain of the router. The handover monitoring portion 13 monitors the number of occurrences of handover processing with each of the other access routers within a fixed time. When a terminal 30 moves to a different subnet (moves between access points for which the access routers are different), the handover control portion 14 transfers a DHCP request of the terminal to the DHCP server which had been used by the terminal before movement, in order to maintain the IP address.

DHCP is a protocol which automatically allocates an IP address and other required information to a computer temporarily connected to the Internet. In a DHCP server, a gateway, DNS server IP address, subnet mask, a range of IP addresses available for allocation to clients, and similar are set; this information is provided to a computer which accesses the server. When a computer ends communication, the address is automatically recovered and is allocated to another computer.

The communication monitoring portion 15 monitors for communication by each terminal 30. The routing management portion 16 determines to which tunnel data packets are to be routed based on position information for terminals 30. The packet transfer portion 17 performs packet transfer processing. The tunnel control portion 18 sets and manages tunnels with access points, and sets and manages tunnels with access routers. The terminal position information database 19 stores information received from the server 40.

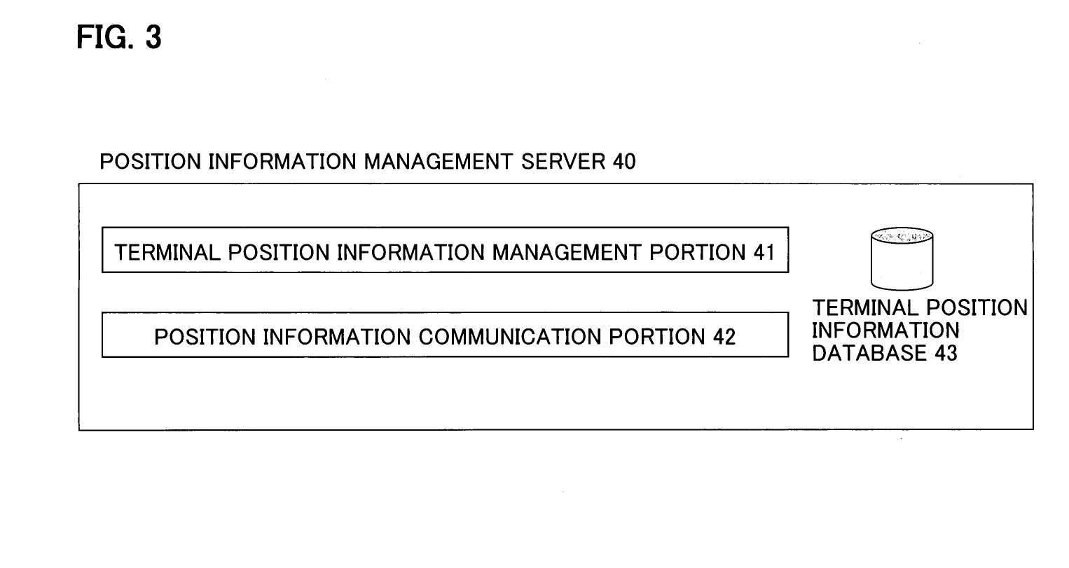

FIG. 3 is a functional block diagram of the position information management server 40. The terminal position information management portion 41 manages MAC addresses and IP addresses for terminals in association with the IP addresses of access routers. The position information communication portion 42 transmits and receives terminal position information with access routers 10. The terminal position information database 43 stores information collected from access routers 10.

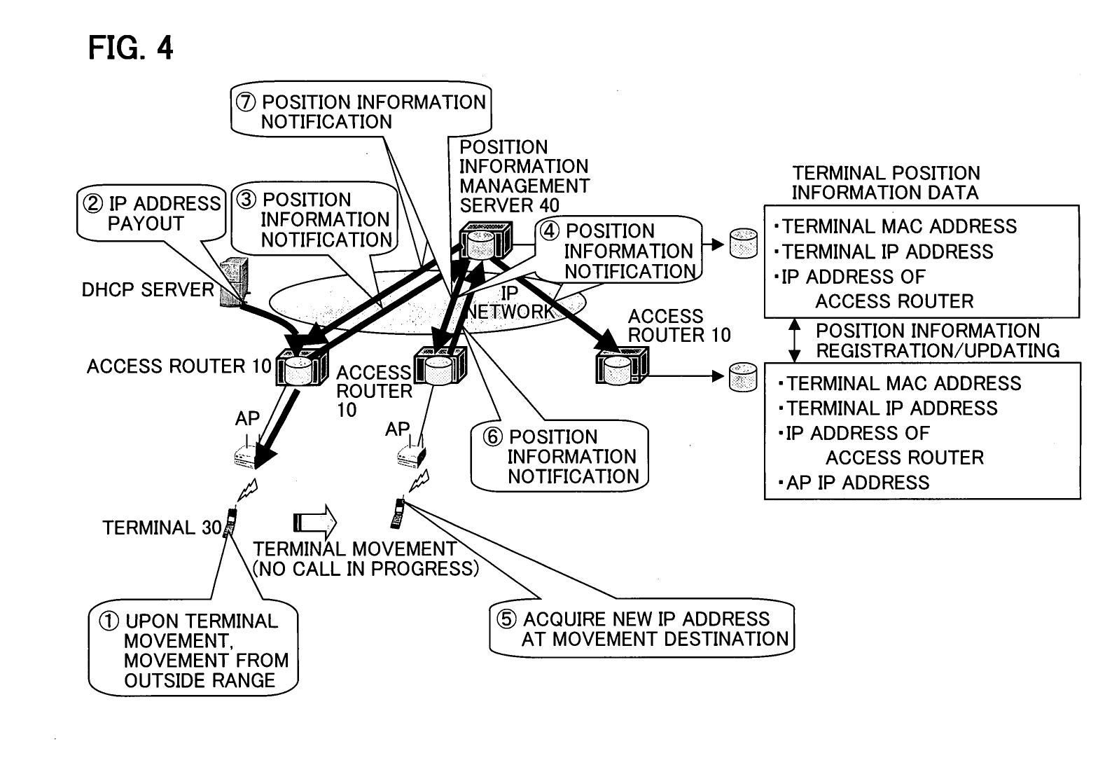

FIG. 4 explains a method of terminal position information notification and management. At the time power is turned on to a terminal within the area of the wireless communication network of this invention, or when a terminal, in the started-up state, moves from an area not covered by the wireless communication network into a covered area, an access point within the domain of an access router enters into a state of wireless connection with the terminal. At this time, normally user authentication is performed, and when authentication is completed, the terminal uses the DHCP protocol to acquire an IP address. The access router 10 monitors DHCP protocol messages, and when an IP address is assigned to the terminal, the access router managing the access point which has entered into the state of wireless connection with the terminal, as the movement origin access router, notifies the position information management server 40, which manages position information for terminals in the network, of the terminal IP address, the terminal MAC address, and the IP address of the access router itself. The position information management server 40 notifies other access routers of the terminal IP address, terminal MAC address, and access router IP address of this notification, so as to share position information for terminals in the network with other access routers. An access router manages information sent to the position information management server 40 and information received from the position information management server as the position information database 19. The position information management portion 12 of the access router manages the IP addresses of access points for terminals in a state of wireless connection with access points in the domain of the access router itself, in order to ascertain to which access point a terminal is connected, in addition to terminal MAC addresses, terminal IP addresses, and the IP addresses of the movement origin access routers of terminals.

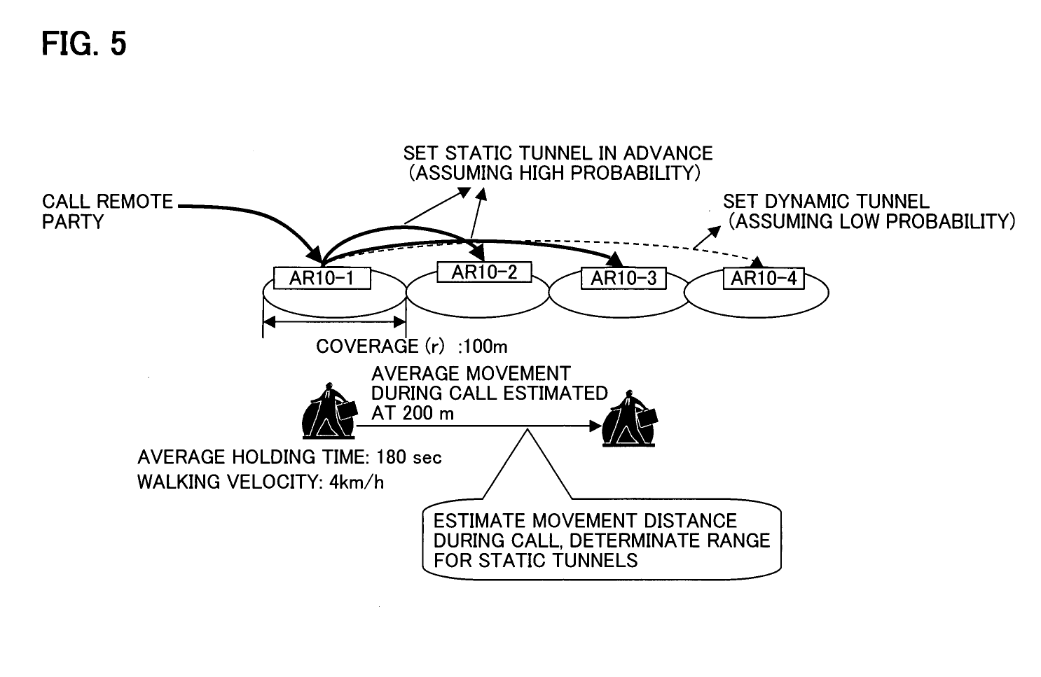

FIG. 5 explains the range over which a static tunnel is set in this aspect of the invention. The wireless communication range covered by one access router 10, the average call holding time (average call time), and the movement velocity (the velocity of walking of a user) are used to estimate the average number of handovers during a call, and the range between access routers for which the probability of occurrence of handovers is high is determined.

If the wireless communication range for one access router is approximately 100 m in diameter, the average call holding time (average call time) is 3 minutes (180 seconds), and the velocity of movement (velocity of walking of a user) is 4 km/h, then the number of handovers is

4000×180/3600/100=2

so that two handovers occur. That is, in the case of the above conditions, when communication is initiated with connection to an access router 10-1, handovers occur between the access router 10-1 connected to the user's terminal at the time of initiation of communication and an access router 10-2 adjacent thereto, and again with a further adjacent access router 10-3. Based on the above results, the tunnel control portion 18 of the access router 10-1 sets in advance static tunnels with the adjacent access router 10-2, with which handovers are anticipated to occur comparatively frequently, and also with the next-adjacent access router 10-3 which is further adjacent to the adjacent access router 10-2. The access router 10-1 does not set a static tunnel with the access router 10-4, which is more distant than the access router 10-3. This is because when communication is begun via the access router 10-1, it is anticipated that the probability of handovers up to the access router 10-4 is low.

Hence when a user terminal connects and begins communication with the access router 10-1, and when movement of the terminal results in the occurrence of handovers between the access router 10-1 and the access router 10-2, and then with the access router 10-3, data is transferred using static tunnels set in advance; and when handover occurs with the access router 10-4, because a static tunnel has not been set, a new tunnel (dynamic tunnel) is set with the access router 10-4, and this dynamic tunnel is used to transfer data.

In this way, each access router sets static tunnels only with access routers for which there is a high probability of the occurrence of handovers as selected using prescribed conditions, rather than setting static tunnels with all other access routers; as a result the load on access routers can be alleviated, while reducing communication interruptions during handovers.

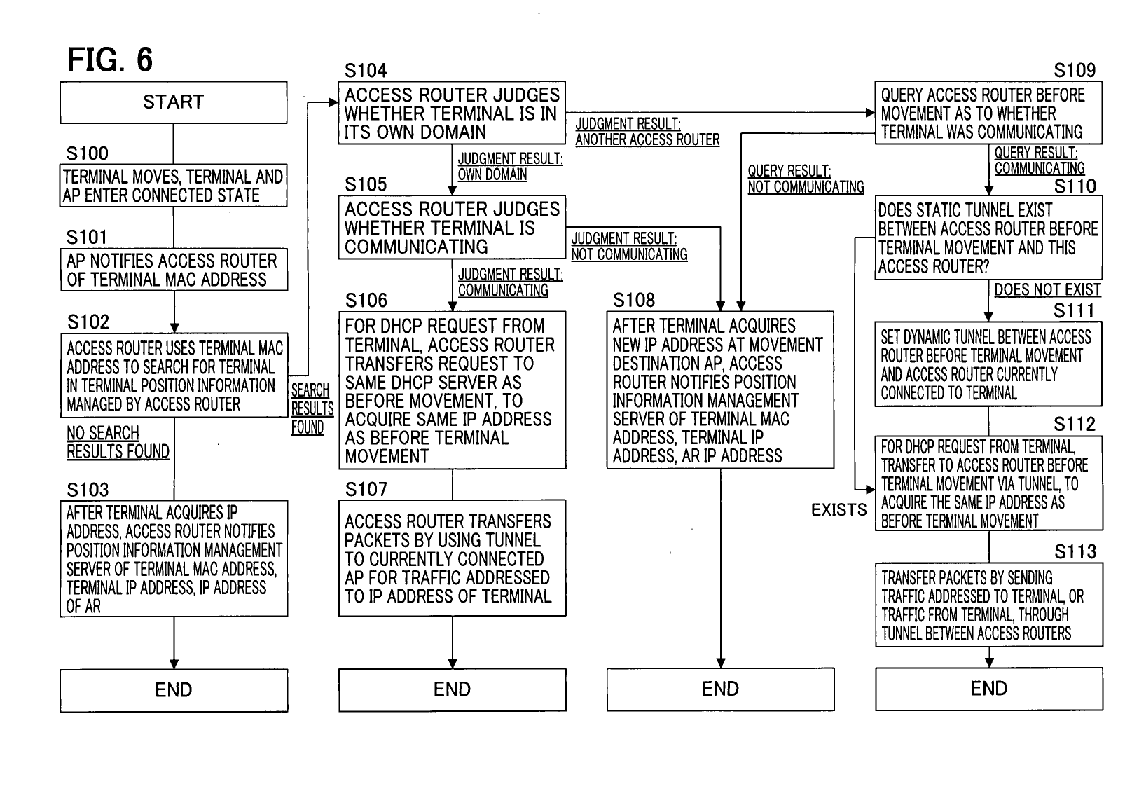

FIG. 6 is a flowchart of access router handover processing in an aspect of the invention. Processing by the access router 10-2 is mainly described for a case in which, in FIG. 5, a terminal 30 moves from the wireless communication range of the access router 10-1 to the wireless communication range of the access router 10-2.

An access point 20-1 in the domain of the access router 10-1 which governs the current position is wirelessly connected to a terminal. The access router sets a static tunnel in the IP layer with each access point in its domain, and so data packets sent from the terminal to the access point pass through the static tunnel and are automatically collected by the access router. The access router becomes an anchor point for transferring data packets to the terminal.

When the terminal moves into the wireless communication range of the access router 10-2, the terminal enters into a wireless connection state with an access point 20-2 in the domain of the access router 10-2 (S100). At this time, the access point 20-2 notifies the access router 10-2 of MAC address information for the terminal (S101). The position information management portion 12 of the access router 10-2 searches the terminal position information database 19 based on the MAC address information of this notification (S102). If the MAC address information of the notification is not registered in the terminal position information database 19, the position information communication portion 11 of the access router 10-2 acquires the terminal IP address, and then notifies the position information management server 40 of the IP address and MAC address for the terminal as well as the IP address of the access router 10-2 itself (S103).

In step S102, if the MAC address information of the notification is registered in the terminal position information database 19, the position information management portion 12 judges whether the terminal is a terminal in the domain of its own access router (S104). Specifically, a judgment is made as to whether the IP address of the access router registered in association with the terminal MAC address information of the notification is the IP address of the access router itself. If the IP address is the IP address of the access router itself, the terminal is judged to be a terminal in the domain of the access router itself. The fact that the terminal is in the domain of the access router itself means that only the access point has changed, and that the access router is the same.

In step S104, if it is judged that the terminal is in the domain of the access router itself, the communication monitoring portion 15 of the access router 10-2 judges whether the terminal is communicating in the domain of the access router itself (S105). If the terminal is communicating, the handover control portion 14 of the access router 10-2 transmits a DHCP request to the same DHCP server as before movement in response to a DHCP request from the terminal, in order to maintain the same IP address as before movement (S106).

The routing management portion 16 and packet transfer portion 17 of the access router 10-2 transmit data packets the destination IP address of which is the terminal IP address through the tunnel addressed to the currently connected access point (S107).

In step S105, if the terminal is not communicating, after the terminal acquires a new IP address from the movement destination access point 20-2, the position information communication portion 11 of the access router 10-2 notifies the position information management server 40 of the IP address and MAC address of the terminal, as well as the IP address of the access router 10-2 itself (S108).

In step S104, if the terminal is judged not to be a terminal in the domain of the access router itself, the communication monitoring portion 15 of the access router 20-1 queries the access router 10-1 which had been connected before the terminal moved as to whether the terminal is communicating (S109). The access router which had been connected before the terminal moved can be determined from the IP address of the access router which is registered in association with the MAC address information for the terminal of the notification.

If the query result indicates that the terminal is not communicating, the processing of the above-described step S108 is performed. If on the other hand the terminal is communicating, the tunnel control portion 18 of the access router 10-2 judges whether there exists a static tunnel with the access router 10-1 which was connected before the terminal movement (S110).

If no tunnel exists, the tunnel control portion 18 sets a tunnel with the access router 10-1 (dynamic tunnel) (S111).

In the case in which in S110 a static tunnel exists, and in the case in which in S111 a dynamic tunnel is set, the handover control portion 14 of the access router 10-2 transfers a response to a DHCP request from the terminal to the access router 10-1 via the tunnel with the access router 10-1, and by transferring the DHCP request from the terminal to the same DHCP server, can maintain the same IP address as before movement (S112).

Then, the routing management portion 16 and packet transfer portion 17 of the access router 10-2 transfer to the terminal data packets addressed to the terminal and received via the tunnel with the access router 10-1, and transfer data packets received from the terminal to the access router 10-1 via the tunnel (S113).

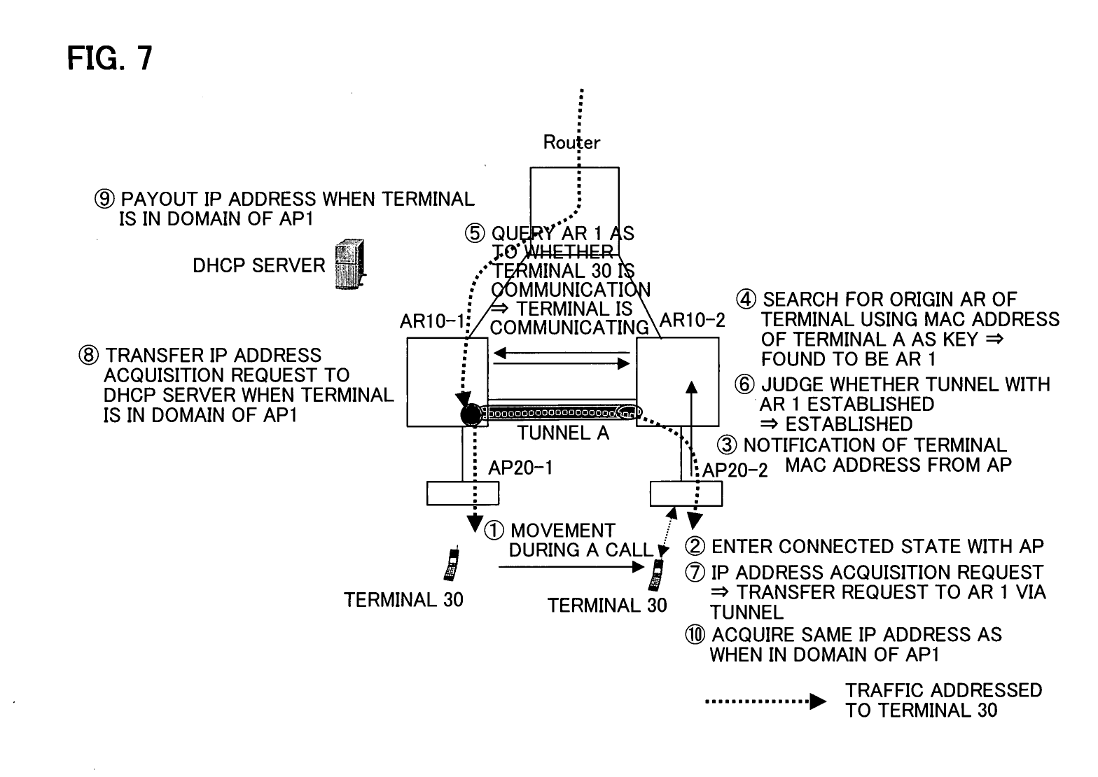

FIG. 7 shows in summary handover processing when a static tunnel is set. FIG. 7 shows handover processing using a static tunnel when, in the flowchart of FIG. 6, a terminal 30 which is communicating moves from the wireless communication range of access router 10-1 to the wireless communication range of access router 10-2; this procedure is the same as in FIG. 6. In FIG. 7, a static tunnel is set in advance, and so data packets are transferred via this static tunnel between the access router 10-1 and the access router 10-2.

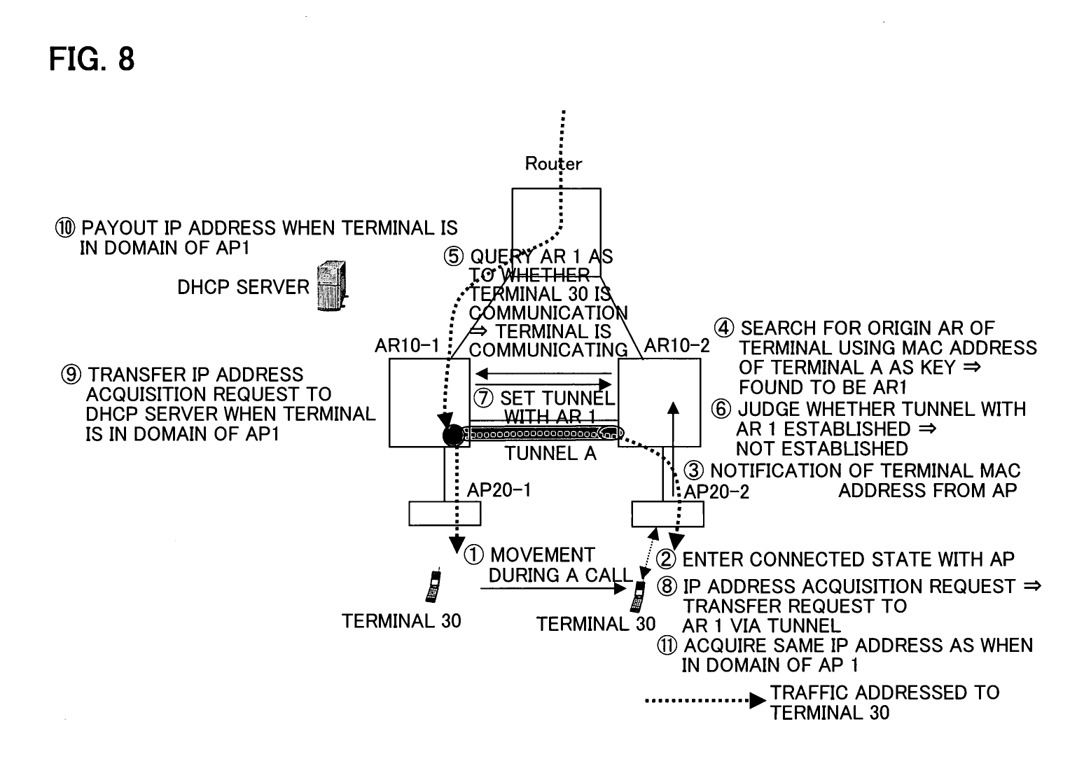

FIG. 8 shows in summary handover processing when a dynamic tunnel is set. FIG. 8 shows handover processing using a dynamic tunnel for a case in which, in the flowchart of FIG. 6, a terminal 30 which is communicating moves from the wireless communication range of access router 10-1 to the wireless communication range of access router 10-2; the procedure is the same as in FIG. 6. Compared with FIG. 7, a procedure to set a tunnel (7) (corresponding to step S111 in FIG. 6) between access router 10-1 and access router 10-2 is necessary. Data packets are transferred between the access routers 10-1 and 10-2 via the dynamic tunnel thus set.

As explained in FIG. 5, in the above-described handover processing, an average number of handovers during an average call is assumed in advance, and access routers with which static tunnels are set are determined in a fixed manner; but the access routers with which static tunnels are set may be modified as appropriate according to the actual frequency of occurrence of handovers.

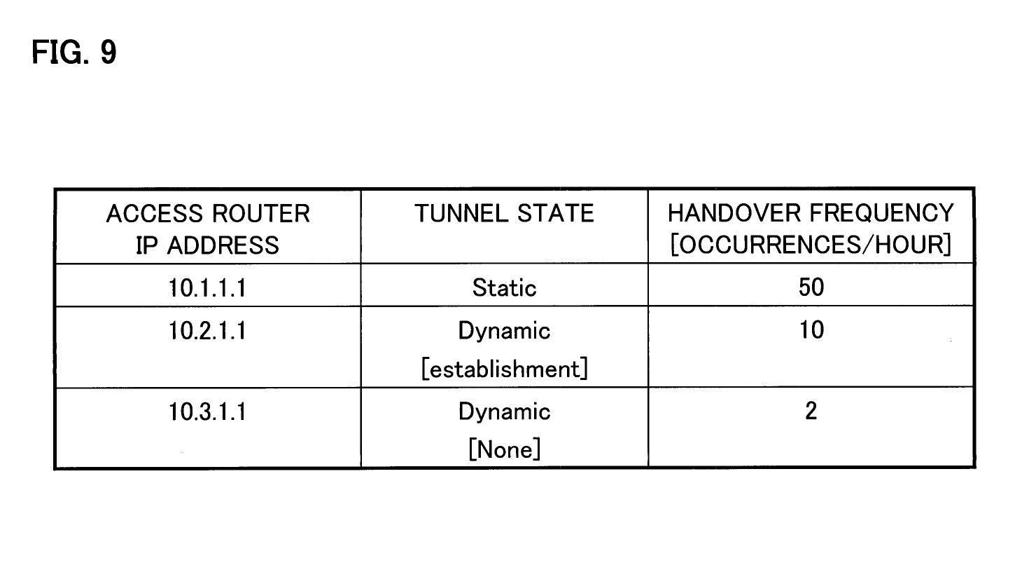

FIG. 9 is a table showing the state of tunnel settings according to handover frequency. This table is updated and managed by the handover monitoring portion 13. The handover monitoring portion 13 monitors handover frequency for (the IP addresses of) access routers with which handovers occur. The tunnel control portion 18 sets a static tunnel with access routers for which the handover frequency exceeds a prescribed threshold. For example, if the threshold is 20 occurrences/hour, then in the example of FIG. 8, a static tunnel is set with the access router (with IP address 10.1.1.1) for which the handover frequency is 50 occurrences/hour.

Dynamic tunnels are set at the time of handover with access routers for which the handover frequency is equal to or lower than the threshold (10.2.1.1 and 10.3.1.1). In the example of FIG. 8, a dynamic tunnel is currently set with an access router (10.2.1.1), but a dynamic tunnel is not set with another access router (10.3.1.1).

Even when at a certain time the handover frequency exceeds the threshold and a static tunnel is set, if thereafter the handover frequency falls to be equal to or less than the threshold, the static tunnel is destroyed, and a dynamic tunnel is set each time handover occurs. Further, when at a certain time the handover frequency is equal to or less than the threshold and a static tunnel is not set, if thereafter the handover frequency exceeds the threshold value, a static tunnel is set.

In this way, by managing handover frequencies and switching between static tunnels and dynamic tunnels as appropriate, static tunnels and dynamic tunnels can be selectively used in an optimal manner. Further, static tunnels can be set with access routers for which there is a high probability of actual handover occurrence, so that tunnels can be set efficiently.

What is claimed is:

1. A communication relay apparatus for relaying communication data between wireless terminals, comprising:
a judgment unit, upon detection of a communication connection with a wireless terminal which has moved from an area of another communication relay apparatus, for judging whether a static tunnel to said other communication relay apparatus has been set; and,
a control unit, when said static tunnel has been set, for executing handover processing to transfer via said static tunnel to said wireless terminal communication data addressed to said wireless terminal which has been transferred from said other communication relay apparatus, and to transfer via said static tunnel communication data from said wireless terminal to said other communication relay apparatus, and, when said static tunnel has not been set, for setting a dynamic tunnel to said other communication relay apparatus, for executing handover processing to transfer to said wireless terminal via said dynamic tunnel communication data addressed to said wireless terminal which is transferred from said other communication relay apparatus and to transfer communication data via said dynamic tunnel from said wireless terminal to said other communication relay apparatus, and for canceling said dynamic tunnel after the completion of handover processing.

2. The communication relay apparatus according to claim 1, further comprising a setting unit, when a static tunnel with said other communication relay apparatus is not set, and if the frequency of handover processing with said other communication relay apparatus exceeds a prescribed value, for setting said static tunnel with said other communication relay apparatus.

3. The communication relay apparatus according to claim 2, wherein, when said static tunnel is set with said other communication relay apparatus, if the frequency of handover processing with said other communication relay apparatus falls to become equal to or less than a prescribed value, said setting unit cancels said static tunnel with said other communication relay apparatus.

4. The communication relay apparatus according to claim 1, further comprising a setting unit for selecting a part of communication relay apparatuses including said other communication relay apparatus from among a plurality of communication relay apparatuses based on a prescribed condition relating to handover, and for setting in advance static tunnels to the selected communication relay apparatuses.

5. The communication relay apparatus according to claim 4, wherein said prescribed condition is an average number of handovers in an average call time of said other communication relay apparatus.
